(19) United States
(12) Patent Application Publication
(10) Pub. No.: US 2015/0301569 A1
(43) Pub. Date: Oct. 22, 2015

(54) POWER CONSERVING APPLIANCE

(71) Applicant: LG ELECTRONICS INC., Seoul (KR)

(72) Inventors: Saerom KIM, Seoul (KR); Sungchul KIM, Seoul (KR); Byeonghee LEE, Seoul (KR)

(21) Appl. No.: 14/689,304

(22) Filed: Apr. 17, 2015

(30) Foreign Application Priority Data
Apr. 17, 2014 (KR) 10-2014-0046234

(51) Int. Cl. G06F 1/26; G06F 1/32; G05B 15/02

(52) U.S. Cl. CPC G06F 1/266; G05B 15/02; G06F 1/3296

(57) ABSTRACT

An appliance is disclosed. The appliance includes a load switch that is connected to a plurality of loads and configured to control power provided to the plurality of loads. The appliance further includes a voltage output unit that is configured to output a respective driving voltage that is appropriate for each load of the plurality of loads based on the load switch being in an on state. The appliance further includes a sub microcomputer that is configured to receive a constant driving voltage from the voltage output unit and transmit a first signal for switching the load switch to an on state based on receiving a power on signal. The appliance further includes a main microcomputer that is configured to control operations of the plurality of loads, receive a first driving voltage, and transmit, to the load switch, a second signal for maintaining the load switch in an on state.

### CROSS-REFERENCE TO RELATED APPLICATION

This application claims the priority benefit of Korean Patent Application No. 10-2014-0046234, filed on Apr. 17, 2014 in the Korean Intellectual Property Office, the disclosure of which is incorporated herein by reference.

### FIELD

This application relates to an appliance and an operation method thereof, and more particularly, to an appliance and an operation method thereof, that satisfy standby power regulations while providing a power failure compensation function.

### BACKGROUND

By virtue of rapid development of technology, high-tech appliances have rapidly spread in each home.

Increase in number of devices increases use of power. When a power plug is connected to a socket, power is supplied to an appliance through a power circuit including a switching mode power supply (SMPS) from a time point when alternating current (AC) power is connected. Accordingly, irrespective of an operation state or standby state of the appliance, power is continuously supplied to the appliance such that predetermined standby power is also continuously consumed in a standby mode.

Recently, as issues in terms of energy conservation have become more important, standby power regulation has been reinforced. In order to satisfy standby power regulation of 0.5 watts (W), an appliance uses an existing power circuit of a standby-dedicated switching mode power supply (SMPS).

An appliance has a power failure compensation function. The power failure compensation function refers to a function whereby an operation is restarted from a time point when the operation is stooped rather than being started from the beginning when power is interrupted and then re-connected due to power failure or a voltage instability area.

A recent appliance includes a touchscreen that receives user touch input to control on/off of power. In this case, in order to design a power button in the form of a touchscreen, standby power of 0.5 watts or less is satisfied using two SMPS circuits.

### SUMMARY

According to an innovative aspect of the subject matter described in the application, an appliance includes a load switch that is connected to a plurality of loads and configured to control power provided to the plurality of loads; a voltage output unit that is configured to output a respective driving voltage that is appropriate for each load of the plurality of loads based on the load switch being in an on state; a sub microcomputer that is configured to receive a constant driving voltage from the voltage output unit and transmit a first signal for switching the load switch to an on state based on receiving a power on signal; and a main microcomputer that is configured to control operations of the plurality of loads, receive a first driving voltage, and transmit, to the load switch, a second signal for maintaining the load switch in an on state based on the load switch being switched to the on state.

The appliance may include one or more of the following optional features. Based on alternating current (AC) input power supplied from a power input unit being interrupted and then re-supplied, the main microcomputer controls the plurality of loads to operate after operating in a stopped state. The appliance further includes a regulator that is configured to increase or reduce the constant driving voltage output from the voltage output unit to a driving voltage appropriate for operating the sub microcomputer. The constant driving voltage is eight volts. The regulator reduces the constant driving voltage to five volts. The appliance further includes a touch input unit.

The sub microcomputer receives a power on signal from the touch input unit. The appliance further includes a rectifier that is configured to perform full-wave rectifying or half-wave rectifying on AC input power supplied by a power input unit; and a smoother that is configured to smooth the rectified power and apply the smoothed, rectified power to the voltage output unit. The appliance further includes a first load driven by the AC input power; and a first load switch that is configured to control power supplied to the first load. The main microcomputer outputs a third signal that causes the first load switch to switch to a closed state upon receiving the first driving voltage. The first driving voltage is five volts.

According to an innovative aspect of the subject matter described in the application, a method of operating an appliance includes the actions of applying a driving voltage to a sub microcomputer from a switching mode power supply (SMPS); in response to receiving a power on signal, transmitting, by the sub microcomputer and to a load switch, a first signal that causes the load switch to switch from an open state to a closed state; applying a first driving voltage to a main microcomputer based on the load switch being closed; in response to receiving the first driving voltage, transmitting a second signal that causes the load switch to maintain a closed state; and supplying power from the voltage output unit to a plurality of loads in response to the load switch being in a closed state.

The actions may include one or more of the following optional features. The first signal is a signal to change from a standby mode to an operating mode. The main computer operates the plurality of loads. At least one operating voltage for a load of the plurality of loads is different than other operating voltages of other loads of the plurality of loads. The plurality of loads comprises an inverter. The plurality of loads comprises a buzzer. The plurality of loads comprises a tub. The plurality of loads comprises an LED. The plurality of loads comprises a fan motor. The plurality of loads comprises a hall sensor relay. The plurality of loads comprises a display unit.

It is an object of the subject matter described in this application to provide an appliance and an operation method thereof, that satisfy standby power regulations while providing a power failure compensation function.

### BRIEF DESCRIPTION OF THE DRAWINGS

FIG. 1 is a block diagram of a configuration of an appliance.

FIG. 2 is a circuit diagram of a circuit configuration of an appliance.

FIG. 3 is a flowchart of an operation method of an appliance.

### DETAILED DESCRIPTION

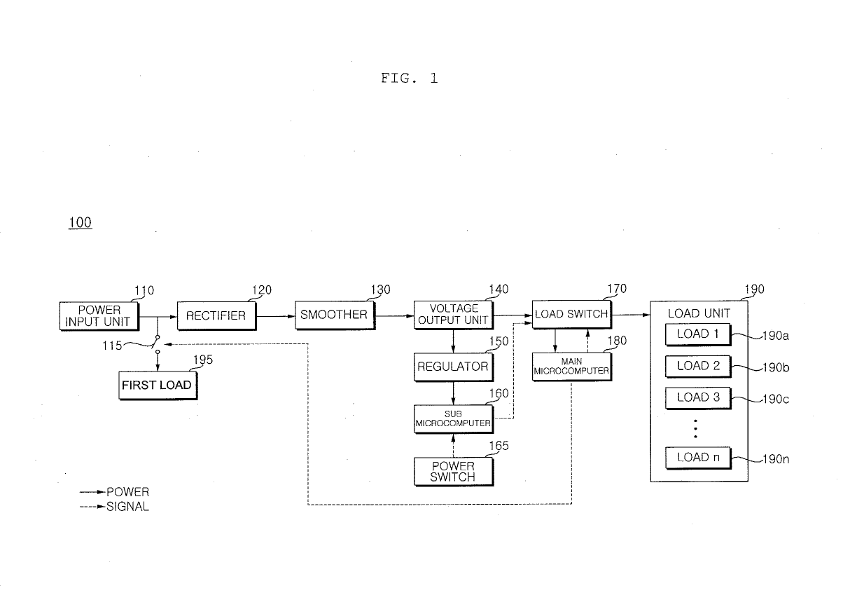

FIG. 1 illustrates an example configuration of an appliance 100.

Referring to FIG. 1, the appliance 100 includes a first load switch 115, a rectifier 120, a smoother 130, a voltage output unit 140, a regulator 150, a sub microcomputer 160, a power switch 165, a load switch 170, a main microcomputer 180, a load unit 190, and a first load 195.

A power input unit 110 supplies alternating current (AC) input power to the appliance 100 in a state in which a power plug is connected to a socket. The power input unit 110 may be a commercially available AC power source and may vary from country to country.

The rectifier 120 is connected between the power input unit 110 and the voltage output unit 140. The rectifier 120 full-wave rectifies or half-wave rectifies AC input power supplied from the power input unit 110. The rectifier 120 may be a circuit in which a plurality of diodes is configured in the form of a bridge. The AC input power supplied from the power input unit 110 is rectified through the rectifier 120 and is supplied to the smoother 130.

The smoother 130 is connected between the rectifier 120 and the voltage output unit 140. The smoother 130 includes at least one capacitor. The smoother 130 may convert power rectified through the rectifier 120 into predetermined magnitude of direct current (DC) power. The DC power converted by the smoother 130 into predetermined magnitude is supplied to the voltage output unit 140.

In some implementations, the appliance 100 may further include a filter unit between the power input unit 110 and the rectifier 120. The filter unit may be an electromagnetic interface (EMI) filter for removing noise component of AC input power supplied by the power input unit 110.

The voltage output unit 140 is connected to an output terminal of the smoother 130. The voltage output unit 140 may be a switching mode power supply (SMPS). The voltage output unit 140 outputs respective driving voltages appropriate for a plurality of loads 190a, 190b, 190c, . . . 190n included in the appliance 100. That is, the voltage output unit 140 stably generates and outputs various levels of voltages required by the plurality of loads 190a, 190b, 190c, . . . 190n. For example, the voltage output unit 140 may output a DC voltage of 8 volts (V), 12 V, 16.5 V, or 22 V. In this case, a voltage output from the voltage output unit 140 is applied to the plurality of loads 190a, 190b, 190c, . . . 190n. In this case, in order to satisfy standby power of 0.5 watts, a voltage of 12 V, 16.5 V, and 22 V may be restrictively applied in a standby mode.

The regulator 150 is connected to one of output terminals of the voltage output unit 140. The regulator 150 boosts or reduces an always, or constant, driving voltage output from the voltage output unit 140 to a driving voltage appropriate for an operation of the sub microcomputer 160. The driving voltage that is boosted or reduced by the regulator 150 is applied to the sub microcomputer 160. For example, when the voltage output unit 140 outputs an always driving voltage of 8 V, the regulator 150 may reduce the always driving voltage to a driving voltage of 5 V appropriate for an operation of the sub microcomputer 160 and output the driving voltage to the sub microcomputer 160.

The sub microcomputer 160 is connected to an output terminal of the regulator 150. The sub microcomputer 160 receives a voltage obtained by boosting or reducing the always driving voltage output from the voltage output unit 140 by the regulator 150. When the power switch 165 receives a power on signal, the sub microcomputer 160 transmits a first signal to the load switch 170. Here, the first signal may be a signal for switching from a standby mode of the appliance 100 to an operation mode. The first signal may be a signal for converting the load switch 170 into an on-state. In some implementations, upon receiving a power on signal, the sub microcomputer 160 may transmit the first signal to the load switch 170 only once.

The power switch 165 may be a user input switch. The power switch 165 may be a touch input unit that receives an input signal in a touch input manner. A user performs power on through the power switch 165. In this case, the power switch 165 transmits the power on signal to the sub microcomputer 160.

The load switch 170 is connected between the voltage output unit 140 and the load unit 190. In order to satisfy standby power, the load switch 170 controls a DC voltage applied to the load unit 190 from the voltage output unit 140. The load switch 170 receives the first signal from the sub microcomputer 160. In this case, the load switch 170 applies a first driving voltage to the main microcomputer 180. Here, the first driving voltage may be a DC voltage of 5 V.

The load switch 170 applies the first driving voltage to the main microcomputer 180 and receives a second signal from the main microcomputer 180 when the main microcomputer 180 wakes up. Here, the second signal is a signal for mainlining an on state of the load switch 170. The load switch 170 continuously receives the second signal in a state in which the main microcomputer 180 wakes up. Upon receiving the second signal, the load switch 170 is maintained in an on state and, accordingly, each output voltage output from the voltage output unit 140 is applied to the plurality of loads 190a, 190b, 190c, . . . 190n.

The main microcomputer 180 is connected to the load switch 170. When the first signal is input to the load switch 170 from the sub microcomputer 160, the load switch 170 is turned on. In this case, the main microcomputer 180 may receive the first driving voltage.

For example, when a load switched is turned on, the main microcomputer 180 may receive a first driving voltage of 5 V from the voltage output unit 140.

In some implementations, when a load switch is turned on, the main microcomputer 180 may receive the first driving voltage that is output from the voltage output unit 140, applied to the regulator 150, and boosted or reduced by the regulator 150.

Upon receiving the first driving voltage, the main microcomputer 180 wakes up. In a wake-up state, the main microcomputer 180 transmits the second signal to the load switch 170. Here, the second signal is a signal for maintaining the load switch 170 to an on state. The main microcomputer 180 continuously transmits the second signal to the load switch 170.

In a wake-up state, the main microcomputer 180 transmits a third signal to the first load switch 115. Here, the third signal is a signal for switching of the first load switch 115 to an on state. When the first load switch 115 is turned on, input power supplied from the power input unit 110 is supplied to the first load 195.

The main microcomputer 180 controls operations of the plurality of loads 190a, 190b, 190c, . . . 190n and the first load 195. When AC input power supplied from the power input unit 110 is interrupted and then re-supplied, input power is interrupted, and the main microcomputer 180 controls the plurality of loads 190a, 190b, 190c, . . . 190n to operate subsequent to an operation in a stop state. That is, the main microcomputer 180 controls the plurality of loads 190a, 190b, 190c, . . . 190n and the first load 195 to perform a power failure compensation function of the appliance 100.

The load unit 190 includes a plurality of loads 190a, 190b, 190c, . . . 190n. When the load unit 190 is connected to the load switch 170 and the load switch 170 turned on, the load switch 170 receives a DC voltage from the voltage output unit 140. Here, the plurality of loads 190a, 190b, 190c, . . . 190n may be various sensors or electronic components disposed in an appliance. For example, with regard to a washing machine, the plurality of loads 190a, 190b, 190c, . . . 190n may be an intelligent power module (IPM), a buzzer, a tub, an LED, a fan motor, a steam, a triode for alternating current (TRIAC), a hail sensor relay, or an LED included in a display unit.

The first load 195 may be a component that receives AC input power supplied from the power input unit 110 and operates. For example, with regard to a washing machine, the first load 195 may be a discharging resistor or hot/cold water. Here, when a power plug is not connected to a socket, the discharging resistor is a resistor for removing residual power in an appliance circuit. When a service engineer repairs the appliance 100, the appliance 100 may include a discharging resistor in order to prevent electric shock.

The first load switch 115 is connected between the power input unit 110 and the first load 195. The first load switch 115 controls AC input power supplied to the first load 195 from the power input unit 110. Upon receiving the third signal from the main microcomputer 180, the first load switch 115 is turned on to apply AC input power to the first load 195.

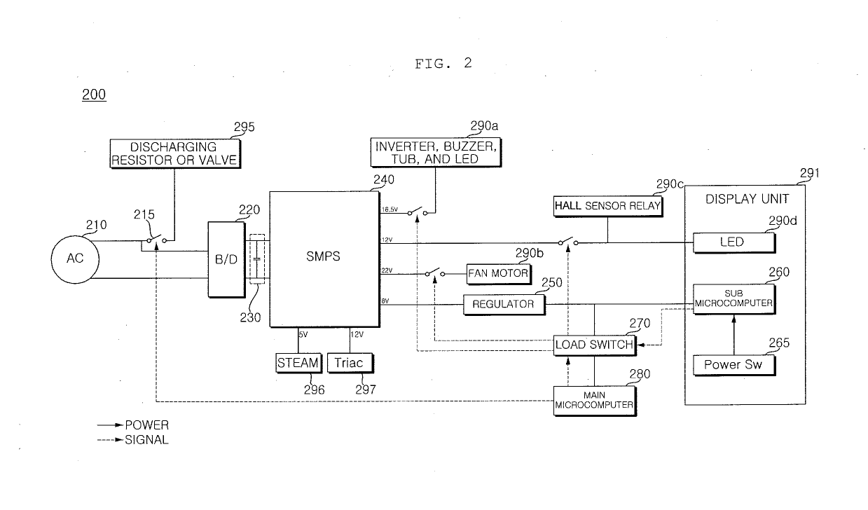

FIG. 2 illustrates an example circuit configuration of an appliance.

In FIG. 2, the appliance is may be a washing machine. The appliance may be any appliance including a television (TV), an air conditioner, a refrigerator, an electric rice cooker, a microwave, a robotic vacuum cleaner, etc.

Referring to FIG. 2, a washing machine 200 includes a first load switch 215, a bridge diode (B/D) 220, a smoother 230, an SMPS 240, a regulator 250, a sub microcomputer 260, a power switch 265, a load switch 270, a main microcomputer 280, and a plurality of loads 290a, 290b, 290c, and 290d.

The bridge diode 220 includes first to fourth diodes that have a bridge circuit configuration. The bridge diode 220 full-wave rectifies or half-wave rectifies AC input power supplied from AC power 210.

The rectified input power is smoothed and converted into predetermined magnitude of DC power while passing through the smoother 230 including at least one capacitor.

The smoothed AC power applied to the SMPS 240.

The SMPS 240 outputs DC voltages required for the respective loads. In some implementations, the SMPS 240 outputs a voltage of 16.5 V to an inverter, buzzer, tub, and LED 290a. In addition, the SMPS 240 outputs a voltage of 22 V to a fan motor 290b. The SMPS 240 outputs a voltage of 12 V to a hall sensor relay 290c. The SMPS 240 outputs a voltage of 12 V to an LED 290d included in a display unit 291. The SMPS 240 outputs a voltage of 5 V to a steam unit 296. In addition, the SMPS 240 outputs a voltage of 12 V to a TRIAC 297.

Here, in order to satisfy standby power regulation of 0.5 watts, a voltage of 16.5 V applied to the inverter, buzzer, tub, or LED 290a, a voltage of 22 V applied to the fan motor 290b, and a voltage of 12 V applied to the hall sensor relay 290c or the LED 290d is not applied in a standby state and is applied only when the load switch 270 is turned on.

The regulator 250 receives an always driving voltage of 8 V from the SMPS 240. The regulator 250 reduces an always driving voltage of 8 V to a driving voltage of 5 V appropriate for an operation of the sub microcomputer 260. The regulator 250 applies a driving voltage of 5 V to the sub microcomputer 260.

The sub microcomputer 260 receives a driving voltage of 5 V from the regulator 250. In this case, while the AC power 210 is supplied, the regulator 250 continuously receives a driving voltage of 5 V. Upon receiving a power on signal from the power switch 265 according to user input, the sub microcomputer 260 transmits the first signal to the load switch 270. Here, the first signal may be a signal for switching from a standby mode to an operation mode. The first signal may be a signal for converting the load switch 170 to an on state. When the first signal is received, the load switch 270 is converted to an on state.

The power switch 265 may be a touch input unit for receiving user touch input. Upon receiving the user touch input, the power switch 265 transmits a power on signal to the sub microcomputer 260.

The load switch 270 receives the first signal from the sub microcomputer 260. In this case, the load switch 270 is converted into an on state. When the load switch 270 is converted into an on state, the load switch 270 supplies a first driving voltage of 5 V to the main microcomputer 230. Here, a first driving voltage of 5 V is a voltage obtained by reducing an always driving voltage output from the SMPS 240 by the regulator 250.

When the load switch 270 is converted into an on state, the load switch 270 turns on a switch connected between the SMPS 240 and the inverter, buzzer, tub, and LED 290a. The load switch 270 turns on a switch connected between the SMPS 240 and the hall sensor relay 290c or the LED 290d.

The main microcomputer 280 receives a first driving voltage of 5 V from the load switch 270. Upon receiving a first driving voltage of 5 V, the main microcomputer 280 wakes up. In a wake-up state, the main microcomputer 280 transmits the second signal to the load switch 270. Here, the second signal is a signal for maintaining the load switch 270 in an on state. The main microcomputer 280 continuously transmits the second signal to the load switch 270 in an operation mode.

In a wake-up state, the main microcomputer 280 transmits the third signal to the first load switch 215. The third signal is a signal for converting the first load switch 215 to a steady-on state.

When the first load switch 215 is converted to an on state, AC input power is supplied to a discharging resistor or valve 295 from the AC power 210.

A plurality of loads includes the inverter, buzzer, tub, and LED 290a. When the load switch 270 is in an on state, the inverter, buzzer, tub, and LED 290a receives a DC voltage of 16.5 V from the SMPS 240.

In addition, the plurality of loads includes the fan motor 290b. When the load switch 270 is in an on state, the fan motor 290b receives a DC voltage of 22 V from the SMPS 240.

The plurality of loads includes the hall sensor relay 290c and the LED 290d. When the load switch 270 is in an on state, the hall sensor relay 290c or the LED 290d receives a DC voltage of 12 V.

The washing machine 200 includes the steam unit 296 for receiving a DC voltage of 5 V from the SMPS 240.

The washing machine 200 includes the TRIAC 297 for receiving a DC voltage of 12 V from the SMPS 240.

The washing machine 200 includes the display unit 291. The display unit 291 may be configured as a touchscreen. Here, the touchscreen may function as an input unit and an output unit by configuring a touch pad and the display unit 291 with an interlayer structure. The display unit 291 may include the LED 290d, the sub microcomputer 260, and the power switch 265.

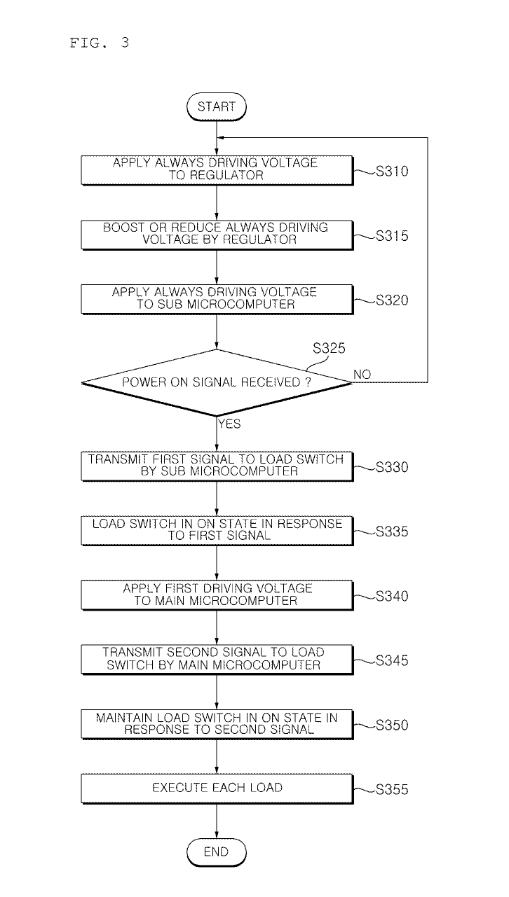

FIG. 3 illustrates an example operation method of an appliance.

Referring to FIG. 3, an AC input voltage supplied from the power input unit 110 is rectified by the rectifier 120, smoothed by the smoother 130, and is converted into a predetermined level of DC voltage. The rectified and smoothed voltage is applied to the voltage output unit 140. An always driving voltage output from the voltage output unit 140 is applied to the regulator 150 (S310).

The regulator 150 boosts or reduces a driving voltage appropriate for an operation of the sub microcomputer 160 (S315).

The regulator 150 applies the boosted or reduced voltage to the sub microcomputer 160 (S320).

While a driving voltage is applied to the sub microcomputer 160, the sub microcomputer 160 determines whether a power on signal is received from the power switch 165 (S325).

Upon receiving the power on signal according to user input, the sub microcomputer 160 transmits the first signal to the load switch 170 (S330). Here, the first signal is a signal for converting a standby mode into an operation mode.

Upon receiving the first signal, the load switch 170 is converted into an on state (S335).

When the load switch 170 is converted into an on state, the first driving voltage output from the voltage output unit 140 is applied to the main microcomputer 180 (S340).

Upon receiving the first driving voltage, the main microcomputer 180 transmits the second signal to the load switch 170 (S345). Here, the second signal is a signal for maintaining the load switch 170 in an on state.

Upon receiving the second signal, the load switch 170 is maintained in an on state (S350). In this case, a DC voltage is applied to the plurality of loads 190a, 190b, 190c, . . . 190n from the voltage output unit 140 and each load is operated under control of the main microcomputer 180 (S355).

Upon receiving the first driving voltage, the main microcomputer 180 transmits the third signal to the first load switch 115. Here, the third signal is a signal for converting the first load switch 115 into an on state. When the first load switch 115 is in an on state, AC input power supplied from the power input unit 110 is applied to the first load 195.

The aforementioned appliance and operation method thereof have the following advantages.

First, when power is interrupted due to power failure during an operation and then re-supplied, the appliance is re-operated from a time point when the operation is stooped, thereby enhancing user convenience.

Second, a circuit including one voltage output unit (e.g., an SMPS) is used, and thus manufacturing costs may be reduced while ensuring the same function as that of a circuit including two voltage output units.

Third, standby power regulation of standby power of 0.5 watts may be satisfied while using one voltage output (e.g., an SMPS).

What is claimed is:

1. An appliance comprising:
a load switch that is connected to a plurality of loads and configured to control power provided to the plurality of loads;
a voltage output unit that is configured to output a respective driving voltage that is appropriate for each load of the plurality of loads based on the load switch being in an on state;
a sub microcomputer that is configured to receive a constant driving voltage from the voltage output unit and transmit a first signal for switching the load switch to an on state based on receiving a power on signal; and
a main microcomputer that configured to control operations of the plurality of loads, receive a first driving voltage, and transmit, to the load switch, a second signal for maintaining the load switch in an on state based on the load switch being switched to the on state.

2. The appliance according to claim 1, wherein, based on alternating current (AC) input power supplied from a power input unit being interrupted and then re-supplied, the main microcomputer controls the plurality of loads to operate after operating in a stopped state.

3. The appliance according to claim 1, further comprising a regulator that is configured to increase or reduce the constant driving voltage output from the voltage output unit to a driving voltage appropriate for operating the sub microcomputer.

4. The appliance according to claim 3, wherein:
the constant driving voltage is eight volts; and
the regulator reduces the constant driving voltage to five volts.

5. The appliance according to claim 1, further comprising a touch input unit,
wherein the sub microcomputer receives a power on signal from the touch input unit.

6. The appliance according to claim 1, further comprising:
a rectifier that is configured to perform full-wave rectifying or half-wave rectifying on AC input power supplied by a power input unit; and
a smoother that is configured to smooth the rectified power and apply the smoothed, rectified power to the voltage output unit.

7. The appliance according to claim 6, further comprising:
a first load driven by the AC input power; and
a first load switch that is configured to control power supplied to the first load,
wherein the main microcomputer outputs a third signal that causes the first load switch to switch to a closed state upon receiving the first driving voltage.

8. The appliance according to claim 1, wherein the first driving voltage is five volts.

9. A method of operating an appliance, the method comprising:
applying a driving voltage to a sub microcomputer from a switching mode power supply (SMPS);
in response to receiving a power on signal, transmitting, by the sub microcomputer and to a load switch, a first signal that causes the load switch to switch from an open state to a closed state;
applying a first driving voltage to a main microcomputer based on the load switch being closed;
in response to receiving the first driving voltage, transmitting a second signal that causes the load switch to maintain a closed state; and
supplying power from the voltage output unit to a plurality of loads in response to the load switch being in a closed state.

10. The method of claim 9, wherein the first signal is a signal to change from a standby mode to an operating mode.

11. The method of claim 9, wherein the main computer operates the plurality of loads.

12. The method of claim 9, wherein at least one operating voltage for a load of the plurality of loads is different than other operating voltages of other loads of the plurality of loads.

13. The method of claim 9, wherein the plurality of loads comprises an inverter.

14. The method of claim 9, wherein the plurality of loads comprises a buzzer.

15. The method of claim 9, wherein the plurality of loads comprises a tub.

16. The method of claim 9, wherein the plurality of loads comprises an LED.

17. The method of claim 9, wherein the plurality of loads comprises a fan motor.

18. The method of claim 9, wherein the plurality of loads comprises a hall sensor relay.

19. The method of claim 9, wherein the plurality of loads comprises a display unit.
